(19) United States
(12) Patent Application Publication
(10) Pub. No.: US 2010/0208922 A1
(43) Pub. Date: Aug. 19, 2010

(54) HEARING SYSTEM NETWORK WITH SHARED TRANSMISSION CAPACITY AND CORRESPONDING METHOD FOR OPERATING A HEARING SYSTEM

(75) Inventors: Lukas Erni, Zurich (CH); Ivo Hasler, Winterthur (CH); Micha Knaus, Jona (CH); Alexander Houben, Zurich (CH)

Correspondence Address: PEARNE & GORDON LLP, 1801 EAST 9TH STREET, SUITE 1200, CLEVELAND, OH, 44114-3108, US

(73) Assignee: PHONAK AG, Stafa (CH)

(21) Appl. No.: 12/670,723

(22) PCT Filed: Jul. 31, 2007
(86) PCT No.: PCT/EP07/57895

§ 371 Date: Jan. 26, 2010

(51) Int. Cl. H04R 25/00

(52) U.S. Cl. 381/315

(57) ABSTRACT

The hearing system (1) is adapted to establishing a communication network (10) between devices (11, 12, 13, 14) of said hearing system (1). It is characterized by a main channel of said communication network (10), which uses at least a portion of the transmission capacity of said communication network, and which is shared between said devices. Said sharing is managed jointly by said devices using a control channel. There is no centralized decision, but a distributed decision. Preferably, said main channel and said control channel are time-multiplexed.

### TECHNICAL FIELD

The invention relates to the field of hearing devices, in particular to networked hearing devices. It relates to methods and apparatuses according to the opening clause of the claims.

Under a hearing device, a device is understood, which is worn in or adjacent to an individual's ear with the object to improve the individual's acoustical perception. Such improvement may also be barring acoustic signals from being perceived in the sense of hearing protection for the individual. If the hearing device is tailored so as to improve the perception of a hearing impaired individual towards hearing perception of a “standard” individual, then we speak of a hearing-aid device. With respect to the application area, a hearing device may be applied behind the ear, in the ear, completely in the ear canal or may be implanted.

For the purpose of the present patent application, a hearing system comprises at least one hearing device and at least one additional device, wherein all devices of the hearing system are operationally connectable within the hearing system. Typically, said additional devices such as another hearing device, a remote control or a remote microphone, are meant to be worn or carried by said individual.

### BACKGROUND OF THE INVENTION

In WO 2004/110099 A2, a hearing aid wireless network is described.

In US 2003/0133582 A1, a hearing aid is described, which has a bluetooth interface. US 2003/0133582 A1 discloses to individually select a single communication connection from several communication connections each to a different signal source. Such a network requires a considerably high bandwidth, which causes a considerable energy consumption.

It is desirable to minimize the energy consumption in a hearing system, in particular in hearing devices. Accordingly, it is desirable to provide a hearing system with a communication network in a particularly energy-efficient way.

In EP 1 262 869 A1, a method is disclosed for providing access to one or more shared resources and/or shared services of a computer network by means of a virtual device.

In EP 0 709 983 A1, an allocation method is disclosed for reusing network resources in a wireless communication network. A network controller connected to a backbone network is used for said allocation.

In EP 1 720 375 A1, it is disclosed to use a translator between two different communication protocols, so as to be able to a access an external communication network from hearing devices which use a communication protocol different from the communication protocol used in said external communication network.

### SUMMARY OF THE INVENTION

One object of the invention is to create a hearing system with a communication network, which has a low energy consumption. Furthermore, a method for operating a hearing system shall be provided, wherein a network interconnecting devices of the hearing system is particularly energy-efficient. In addition, a corresponding use of a communication protocol shall be provided.

Another object of the invention is to provide for an efficient use of the transmission capacity of a network within a hearing system.

Another object of the invention is to provide for an efficient use of the bandwidth of a network within a hearing system.

Another object of the invention is to provide a way to operate a network within a hearing system at a particularly low carrier frequency.

Another object of the invention is to provide for a particularly stable network within a hearing system.

Another object of the invention is to provide for a low radiation exposure of users of hearing systems.

Further objects emerge from the description and embodiments below.

At least one of these objects is at least partially achieved by apparatuses and methods according to the patent claims.

The hearing system is adapted to establishing a communication network between devices of said hearing system. It is characterized by a main channel of said communication network, which uses at least a portion of the transmission capacity of said communication network, and which is shared between said devices.

The method for operating a hearing system comprises the steps of
a) establishing a communication network between devices of said hearing system;
b) sharing a main channel, which uses at least a portion of the transmission capacity of said communication network, between said devices.
   This allows for an efficient, in particular energy-efficient, use of radiation for a hearing system network and/or the hearing system can be operated with low power consumption, with a low transmission capacity, with a low bandwidth and/or at a low carrier frequency. The bandwidth of a network within a hearing system can be used very efficiently.

An efficient use of a wireless communication network is possible, and only a low amount of radiation has to be emitted.

In particular, said main channel is shared between all the devices participating in the communication network.

In particular, said sharing means that said main channel, i.e. its transmission capacity, is usable in full or in part by any of said devices. Accordingly, it has to be managed, when and by which of said devices the shared transmission capacity may be used.

In particular, said sharing means that each of said devices device is capable of using—in full or in part—said main channel, i.e. its transmission capacity.

In one embodiment, for each of said devices, its maximum transmission capacity in said communication network is substantially equal to its maximum receiving capacity in said communication network.

In one embodiment, all of said devices have substantially the same maximum transmission capacity in said communication network.

The term communication network implies that all participants in the network, i.e. all said devices, are capable of transmitting data to the network and of receiving data from the network. I.e. the communication connections between said participants in the network, i.e. between any two of said devices, are bidirectional. This does, of course not exclude that the hearing system may comprise devices which can only receive data from the network but not transmit data to the network or devices which can only transmit data to the network but receive data from the network or devices which neither can transmit data to the network not can receive data from the network. Such devices are not considered to participate in the network, i.e they are not devices between said network is established.

Said main channel typically uses more than 80% of said transmission capacity, in particular more than 90% or even more than 95%.

Said network may make use of one or more of the following ways of data transmission: transmission via acoustic waves, in particular via ultrasound, transmission via electromagnetic waves, in particular via radio frequency waves or optical waves, in particular infrared waves, wirebound transmission (e.g., electrical or optical). Accordingly, said transmission capacity is possibly composed of partial transmission capacities of two or more of the before-mentioned different ways of data transmission.

Accordingly, said main channel may make use of two or more of the before-mentioned ways of data transmission. Typically, said main channel uses only one of the before-mentioned ways of data transmission, in particular electromagnetic waves, more particularly radio frequency waves, typically using a single carrier frequency.

In one embodiment, the transmission capacity of said main channel is substantially equal to the transmission capacity used for transmitting two monophonic audio signal channels within the hearing system.

In one important embodiment, said sharing is managed jointly by said devices, i.e. by the devices participating in the network. In particular, said sharing is managed by all said devices. In particular, each of said devices participates in said managing of said sharing said transmission capacity.

Said jointly managing said sharing can in particular comprise that each of said devices (or at least one of said devices) can reject requests for the use of said main channel or of a part thereof and/or approve the use of said main channel or of a part thereof.

Said managing said sharing in a jointly manner provides for an improved combinability of devices forming a hearing system. This is, because no central decision unit deciding about the use of said main channel is required, which would require to have one device, which is distinguished from the other device(s) in that it comprises said central decision unit. It is, nevertheless, thinkable to design the hearing system such that there is such a central decision unit, possibly in such a way, that each device participating in the network is—with respect to its (hardware and software) resources—capable of carrying out the function of said central decision unit, and it is, e.g., upon start-up of the network, decided, which one of the devices does so. Nevertheless, if such a device embodying such a central decision unit would for some reason discontinue participating in the network, further precautions would have to be taken in order to be able to properly continue managing said sharing. Therefore, a system, realizing said jointly managing said sharing is a very stable system.

As has been pointed out, if there is no centralized decision, but a distributed decision, a high degree of modularity of a hearing system can be achieved, i.e., there is no need to have a particular device which would necessarily have to be present and active in the hearing system; and said sharing can be managed already if any at least two devices, which are in principle suitable for use in such a hearing system, are put together.

One embodiment is characterized by a control channel which is used for managing said sharing. Usually, such a control channel will use at least a portion of the transmission capacity of said communication network.

Typically, said control channel is separate from said main channel.

In one embodiment, said main channel and said control channel together use substantially the full transmission capacity of the communication network.

Typically, the transmission capacity of said control channel amounts to at most 10%, in particular at most 5% of the transmission capacity of said main channel.

Said control channel may make use of one or more of the following ways of data transmission: transmission via acoustic waves, in particular via ultrasound, transmission via electromagnetic waves, in particular via radio frequency waves or optical waves, in particular infrared waves, wirebound transmission (e.g., electrical or optical). Although in many cases, the way or ways of data transmission used by the control channel will be a way or ways of data transmission used by the main channel, it is also possible that for the control channel, a way or ways of data transmission is/are used, which is/are not used by the main channel.

In one embodiment, said communication channel comprises synchronization data, in particular data for establishing a network clock within the network.

In one embodiment, said main channel and said control channel are time-multiplexed. This allows to use one single carrier frequency, e.g., if using electromagnetic waves.

It is also possible to realize said main channel and said control channel in a frequency-multiplexed way.

In one embodiment, each of said devices is capable of using said control channel for communicating requests for the use of at least a portion of said main channel.

In one embodiment, each of said requests comprises a task identifier identifying a task or a type of task for which a use of said at least one portion of said main channel is requested. Typically, said type of task is or comprises a priority indicator, e.g., a priority value, wherein a priority indicator can be used to decide which of two or more tasks that cannot simultaneously be carried out shall be carried out.

In one embodiment, each of said devices comprises a storage unit in which at least one task identifier is stored. In particular, such a task identifier identifies a task currently using at least a portion of said main channel. It is nevertheless possible to store said task identifier in a central storage unit, but this tends to lead to a less stable system. Another thinkable way would be to store said task identifier only in the intiating device, i.e. in that device which requested the corresponding task, but also this tends to lead to a less stable system.

In one embodiment, said use of at least a portion of said main channel is permitted if, within a prescribable time span, said request is not rejected by any of said devices. Said rejection is typically communicated via said control channel.

In one embodiment, said use of at least a portion of said main channel is permitted if, within a prescribable time span, the requesting device does not receive a rejection for the requested task via said control channel.

In one embodiment, said use of at least a portion of said main channel is permitted if said request is approved by at least one of said devices. E.g., said use can be permitted if the requesting device receives an approval from that device, which initiated the or a task which currently uses a required portion of said transmission capacity.

In one embodiment, said use of at least a portion of said main channel is permitted if said request is approved by each of said devices including or excluding the requesting device.

Said approval is typically communicated via said control channel.

In one embodiment, said use of at least a portion of said main channel is permitted if the requesting device receives an approval from each of said devices including or excluding the requesting device.

In one embodiment, each of said requests comprises a task identifier identifying a task or a type of task for which a use of said at least one portion of said main channel is requested, and wherein said task identifier comprises a priority indicator, wherein a rejection or approval of a request is dependent on said priority indicator. Typically, a priority indicator received with a request will be compared to the priority indicator of a task currently using at least a portion of said main channel required by the requested task. If the received priority indicator is valued higher than the priority indicator of a current task, said current task will typically be terminated so as to free (release) transmission capacity required by the requested task, and the requested task will be granted, i.e. the use of the main channel or of a part thereof will be permitted and the task will be carried out.

In one embodiment, each device receiving a request comprising a priority indicator will compare the received priority indicator with a priority indicator(s) stored in its storage unit. Typically, if the received priority indicator is valued higher than the priority indicator in the storage unit, the device will communicate its approval and replace the priority indicator in the storage unit by the priority indicator received with the request.

In one embodiment, each of said devices comprises the same type of transmission unit for participating in said network.

In one embodiment, each of said devices comprises the same type of receiving unit for participating in said network.

In one embodiment, transmitting unit and receiving unit are combined in one transceiving unit, and each of said devices comprises the same type of transceiving unit for participating in said network, e.g., the same transceiver chips.

Typically, said communication network is a wireless network.

The use according to the invention is a use of a communication protocol for sharing transmission capacity in a communication network between devices of a hearing system; in particular, said communication protocol defines a control channel, wherein said control channel is used for managing said sharing. Features of further uses correspond to features of hearing systems and/or methods according to the invention.

In the invention, at least a portion of the transmission capacity is a shared resource.

The advantages of the methods correspond to the advantages of corresponding hearing systems.

Further preferred embodiments and advantages emerge from the dependent claims and the figures.

### BRIEF DESCRIPTION OF THE DRAWINGS

Below, the invention is described in more detail by means of examples and the included drawings. The figures show:

FIG. 1 a schematic illustration of a hearing system with a communication network;

FIG. 2 a flow chart illustrating a portion of a network protocol;

FIG. 3 a flow chart illustrating a portion of a network protocol.

The reference symbols used in the figures and their meaning are summarized in the list of reference symbols. Generally, alike or alike-functioning parts are given the same or similar reference symbols. The described embodiments are meant as examples and shall not confine the invention.

### DETAILED DESCRIPTION OF THE INVENTION

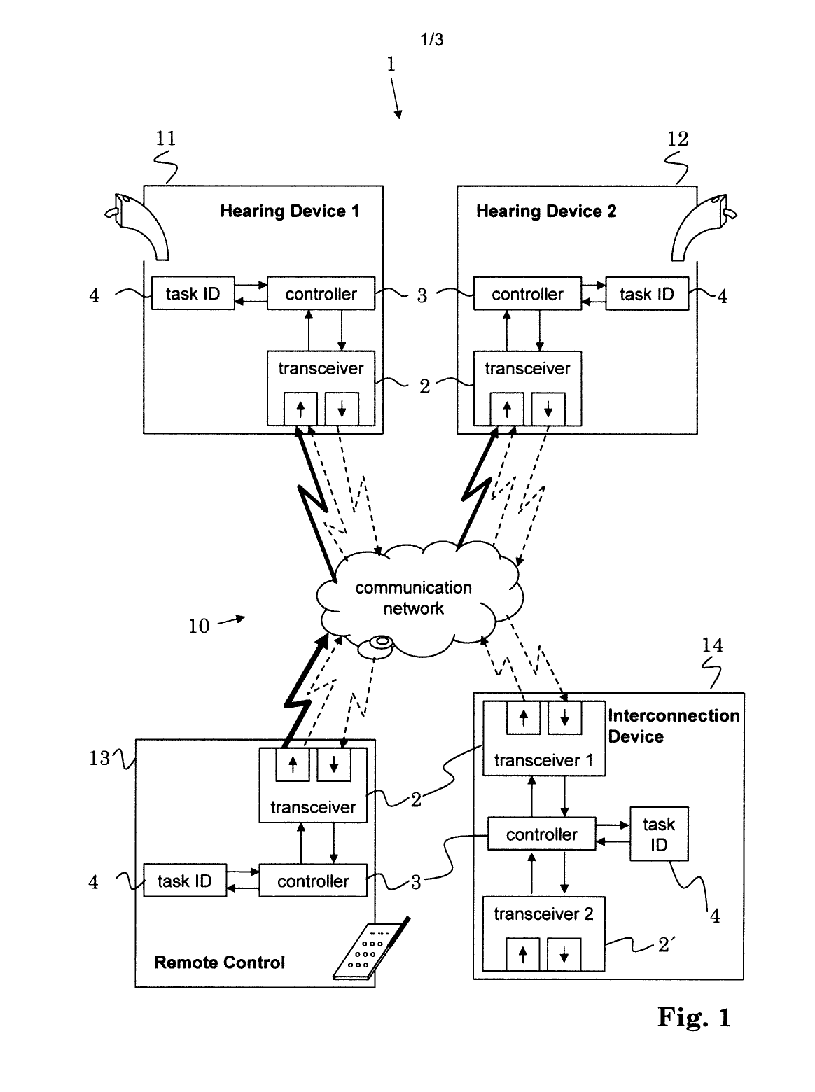

FIG. 1 shows a schematic illustration of a hearing system 1 with a wireless communication network 10. The hearing system 1 comprises two hearing devices 11,12 a remote control 13 and another device 14, in particular an interconnection device 14. All the devices 11,12,13,14 participate in the network 10 and are therefore operationally interconnected by bidirectional links. Each of the devices 11,12,13,14 comprises a transceiver 2, a controller 3 and a storage unit 4. The interconnection device 14 comprises, in addition, a second transceiver 2′, by means of which it can communicate to other networks, e.g., a Bluetooth network. Further details of the devices 11, 12, 13, 14 are not shown in FIG. 1.

The transmission capacity of the network 10 is distributed among a main channel and a control channel. Thin dashed arrows indicate communication via the control channel, and bold arrows indicate communication using the main channel.

The main channel (high-bandwidth channel) uses the major part of the transmission capacity of the network 10, and the control channel (low-bandwidth channel) uses only a minor part of the transmission capacity of the network 10. The main channel is, e.g., configurable as an audio channel (for streaming audio signals), e.g., configurable as two unidirectional audio channels (stereo) or as one bidirectional channel or as two independent (monophonic) channels. The use of the main channel is managed via the control channel; i.e. by means of the control channel, it is decided which device may use the main channel or a part thereof for a task to be carried out, e.g., upon request of a user of the hearing system 1.

The network 10 uses only one radio frequency carrier frequency, which furthermore is rather low, so as to provide just enough bandwidth and transmission capacity while keeping power consumption low, which is particularly important for hearing devices.

Main channel and control channel are realized in a time-multiplexed manner. Furthermore, to each of the devices 11,12,13,14 a time slot is assigned within the control channel, in which that particular device can transmit data. The control channel is evaluated by each of the devices 11,12,13,14.

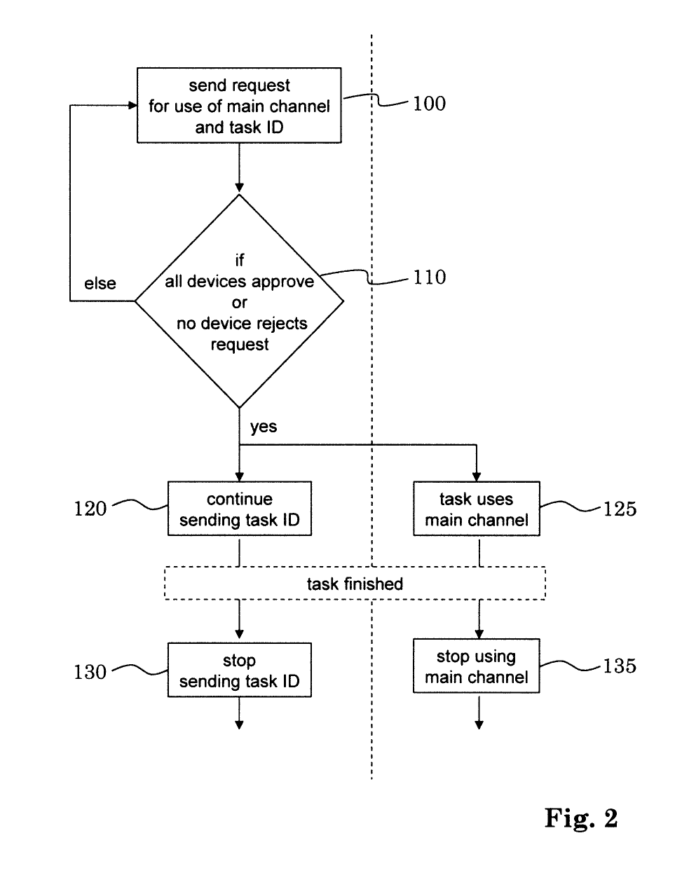

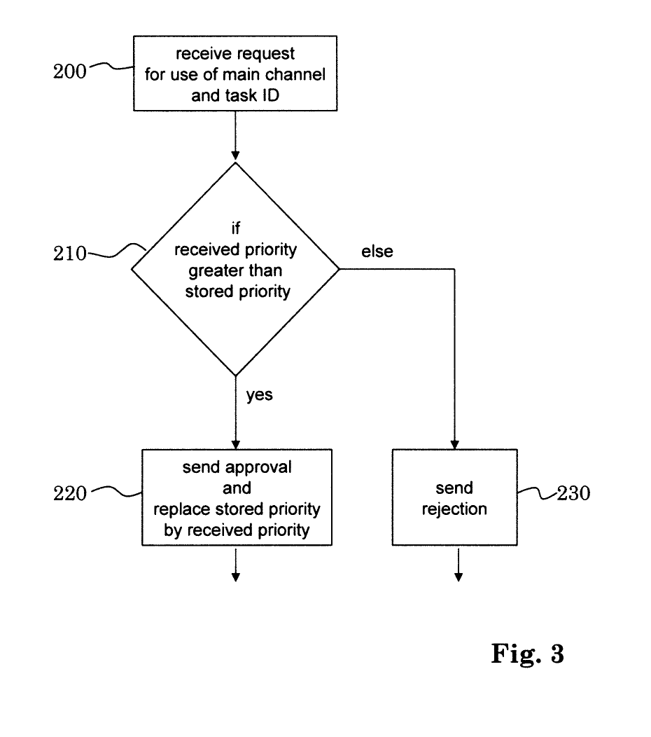

The management of the use of the main channel is carried out in a distributed manner, such that each of said devices participates therein. A corresponding network protocol is discussed in conjunction with FIGS. 2 and 3, which show flow charts illustrating a portion of such a network protocol each.

FIG. 2 illustrates a portion of a network protocol related to requesting the use of the main channel. To the right of the vertical dashed line, steps concerning the use of the main channel are indicated, whereas to the left of said line, there are prevailingly steps which concern the control channel.

One device of the hearing system is triggered to carry out a task requiring the use of (at least a portion of) the main channel. It can be triggered, e.g., automatically or by the user. Thereupon, in step 100, that requesting device sends via the control channel a corresponding request, which includes a task identifier, which is or comprises a priority indicator. Then, the requesting device waits for information communicated via the control channel by the other devices.

If none of the devices rejects said request or—optionally—if said request is approved by all the other devices (see step 110), the requesting device can use the main channel (or the required portion thereof) and will carry out said task (step 125), and in addition, it is possible to repeatedly send a keep-alive-indicator, e.g., the request or the task identifier or the priority indicator, as long as the task is carried out (step 120). It is also possible in step 110 to continue with steps 120 and (optionally) step 125 if an approval from at least one of the devices or from a group of the devices is received, e.g., from those devices which currently use a portion of the main channel required for carrying out the requested task.

Otherwise, the requesting device will return to step 100 and send the request again, so that the task can possibly be carried out sooner or later.

When the task is finished, the requesting device will discontinue using the main channel (step 135), so that the freed transmission capacity can be used for other tasks. This is indicated via the control channel by discontinuing said sending of the keep-alive-indicator (step 130) and/or by sending a termination indicator.

FIG. 3 illustrates, how the input for step 110 comes about; more particularly, it indicates what happens with respect to another device when a requesting device sends its request.

In step 200, said other device receives said request. As has been put forward in conjunction with FIG. 1, each of the devices 11,12,13,14 comprises a storage unit in which at least one task identifier, in particular at least one priority indicator, is stored. Said stored task identifier identifies a task currently using the main channel. If the main channel is unused, e.g., upon startup, the task identifier can be set to a null value. If the received priority indicator is valued higher than the stored priority indicator (step 210), said other device will (optionally) send an approval via the control channel and, in addition, replace the stored priority indicator by the received priority indicator (step 220). Otherwise, said other device will send a rejection via the control channel (step 230).

In the following, an illustrative example of an application of the network protocol is given with reference to FIG. 1 and FIGS. 2 and 3.

It is assumed that the remote control 13 comprises the function of playing music, e.g., from MP3 files, and the user of hearing system 1 is currently listening to music streamed as a stereo audio stream from remote control 13 to the hearing devices 11,12 via the main channel (a monophonic audio stream for each hearing device). The bold arrows indicate this audio stream. The priority value of this type of task can be, e.g., 30, so that the value 30 should be stored in each of the storage units 4.

Then, a telephone call comes in, and the user accepts it, e.g., by pressing a button of the interconnection device 14 (not shown). It is furthermore assumed that the interconnection device 14 is, by means of its second transceiver unit 2′, connected to the user's mobile phone (not shown) via a Bluetooth network (not shown).

Said pressing of said button of the interconnection device 14 triggers an attempt to stream audio signals from the user's mobile phone to both hearing devices 11,12. Accordingly, interconnection device 14 will check the availability of the main channel for this task. For this, interconnection device 14 will transmit a request with a certain priority indicator, e.g., a priority value of 40, via the control channel (cf. step 100).

The request with the priority value of 40 is received by the other devices 11,12,13 (cf. step 200) and will be compared to the priority value (30) stored in the respective storage units 4 (cf. step 210). A higher priority value shall be considered to indicate a higher importance of the task. Accordingly, devices 11,12,13 will transmit their approval with the requested task (cf. step 220) and store the received priority value (40) in its storage units 4 (cf. step 230).

Note that more generally it is possible to check if there is sufficient transmission capacity for carrying out a requested task simultaneously with the currently running task(s).

The remote control 13, which is the initiating device of the current task, will, in addition, terminate its task, i.e. stop using the main channel and discontinue sending its priority indicator (30) (cf. step 130) and/or send a termination indicator.

The interconnection device 14 will then use the main channel in order to let the user make the phone call (cf. step 125). During this, interconnection device 14 can repeatedly send the priority value (40) (cf. step 120). The remote control, in the meantime, will try to resume its task by repeatedly sending requests (with priority value 30) (cf. steps 110 to 100), but without success, since 30<40.

Later, the user will finish his phone call. Thereupon, interconnection device 14 will discontinue using the main channel for this task (cf. step 135) and communicate this, e.g., by discontinuing sending its priority value (cf. step 130) and/or by sending a termination indicator. Thereupon, the priority values in the storage units will be deleted and, upon the next request from the remote control 13, be replaced by the value of 30 (cf. steps 210, 220), and remote control 13 can resume its task, and accordingly, the initial status (listening to music from the remote control 13) is reinstalled.

With respect to priority indicators, it is also possible to provide that in each device or at least in some of the devices receiving a priority indicator, the received priority indicator will be converted into a priority value, wherein it is possible to provide that from the same priority indicator different devices can derive different priority values. E.g., it is possible to provide lookup tables or conversion tables in the devices for determining a priority value from a priority indicator, which may be at least partially individual to the respective device.

With respect to decisions about the granting of requests, it is to be noted that it is possible to do without approvals and to rely on rejections, possibly solely on rejections.

### LIST OF REFERENCE SYMBOLS

1 hearing system
2,2′ transceiver, transmitting and receiving unit
3 controller, control unit
4 storage unit
10 communication network
11 device, hearing device
12 device, hearing device
13 device, remote control
14 device, interconnection device
100-230 steps

What is claimed is:

1. A hearing system adapted to establishing a communication network between devices of said hearing system, comprising
a main channel of said communication network, which uses at least a portion of the transmission capacity of said communication network, and which is shared between said devices.

2. The hearing system according to claim 1, wherein said sharing is managed jointly by said devices.

3. The hearing system according to claim 1, further comprising a control channel which is used for managing said sharing.

4. The hearing system according to claim 3, wherein said main channel and said control channel are time-multiplexed.

5. The hearing system according to claim 3, wherein each of said devices is capable of using said control channel for communicating requests for the use of at least a portion of said main channel.

6. The hearing system according to claim 5, wherein each of said requests comprises a task identifier identifying a task or a type of task for which a use of said at least one portion of said main channel is requested.

7. The hearing system according to claim 6, wherein each of said devices comprises a storage unit in which a task identifier is stored.

8. The hearing system according to claim 5, wherein said use of at least a portion of said main channel is permitted if, within a prescribable time span, the requesting device does not receive a rejection from any of said devices.

9. The hearing system according to claim 5, wherein said use of at least a portion of said main channel is permitted if said request is approved by at least one of said devices including or excluding the requesting device.

10. The hearing system according to claim 7, wherein each of said requests comprises a task identifier identifying a task or a type of task for which a use of said at least one portion of said main channel is requested, and wherein said task identifier comprises a priority indicator, wherein a rejection or approval of a request is dependent on said priority indicator.

11. The hearing system according to claim 1, wherein each of said devices comprises the same type of transmission unit for participating in said network.

12. The hearing system according to claim 1, wherein each of said devices comprises the same type of receiving unit for participating in said network.

13. The hearing system according to claim 1, wherein said communication network is a wireless network.

14. A method for operating a hearing system, comprising the steps of
a) establishing a communication network between devices of said hearing system; and
b) sharing a main channel, which uses at least a portion of the transmission capacity of said communication network, between said devices.

15. The method according to claim 14, comprising the step of jointly managing said sharing by said devices.

16. The method according to claim 14, comprising the step of carrying out said sharing by means of a control channel.

17. The method according to claim 16, comprising the step of time-multiplexing said main channel and said control channel.

18. The method according to claim 16, comprising the step of using said control channel for communicating requests for the use of at least a portion of said main channel.

19. The method according to claim 18, wherein each of said requests comprises a task identifier identifying a task or a type of task for which a use of said at least one portion of said main channel is requested.

20. The method according to claim 19, comprising for each of said devices
receiving a task identifier via said control channel and storing said task identifier in the respective device.

21. The method according to claim 18, wherein after one of said devices has communicated said request, said use of at least a portion of said main channel is permitted if, within a prescribable time span, the requesting device does not receive a rejection from any of said devices.

22. The method according to claim 18, wherein after one of said devices has communicated said request, said use of at least a portion of said main channel is permitted if said request is approved by at least one of said devices.

23. The method according to claim 20, wherein each of said requests comprises a task identifier identifying a task or a type of task for which a use of said at least one portion of said main channel is requested, and wherein said task identifier comprises a priority indicator, wherein a rejection or approval of a request is dependent on said priority indicator.

24. The method according to claim 1, wherein said communication network is a wireless network.

25. Use of a communication protocol for sharing transmission capacity in a communication network between devices of a hearing system.

26. The use according to claim 25, wherein said communication protocol defines a control channel, wherein said control channel is used for managing said sharing.

27. The hearing system according to claim 8, wherein each of said requests comprises a task identifier identifying a task or a type of task for which a use of said at least one portion of said main channel is requested, and wherein said task identifier comprises a priority indicator, wherein a rejection or approval of a request is dependent on said priority indicator.

28. The hearing system according to claim 9, wherein each of said requests comprises a task identifier identifying a task or a type of task for which a use of said at least one portion of said main channel is requested, and wherein said task identifier comprises a priority indicator, wherein a rejection or approval of a request is dependent on said priority indicator.

29. The method according to claim 21, wherein each of said requests comprises a task identifier identifying a task or a type of task for which a use of said at least one portion of said main channel is requested, and wherein said task identifier comprises a priority indicator, wherein a rejection or approval of a request is dependent on said priority indicator.

30. The method according to claim 22, wherein each of said requests comprises a task identifier identifying a task or a type of task for which a use of said at least one portion of said main channel is requested, and wherein said task identifier comprises a priority indicator, wherein a rejection or approval of a request is dependent on said priority indicator.
